(19) United States
(12) Patent Application Publication
(10) Pub. No.: US 2026/0073268 A1
(43) Pub. Date: Mar. 12, 2026

(54) Gibbs State-Based Quantum Optimization for Combinatorial Optimization Problems

(71) Applicant: International Business Machines Corporation, Armonk, NY (US)

(72) Inventors: Jae-Eun PARK, Wappingers Falls, NY (US); Vaibhaw KUMAR, Frederick, MD (US); Dimitrios ALEVRAS, WEST CHESTER, PA (US)

(21) Appl. No.: 18/829,642

(22) Filed: Sep. 10, 2024

(51) Int. Cl. G06N 10/60; G06N 10/20

(52) U.S. Cl. CPC G06N 10/60; G06N 10/20

(57) ABSTRACT

Systems and techniques that facilitate Gibbs state-based quantum optimization for combinatorial optimization problems are provided. For example, one or more embodiments described herein can comprise a system, which can comprise a memory that can store computer executable components. The system can also comprise a processor, operably coupled to the memory that can execute at least one of the computer executable components that can prepare a Gibbs state of a quantum system that represents a combinatorial optimization problem, wherein the Gibbs state is a quantum state that minimizes free energy of the quantum system. The at least one of the computer executable components can further initialize a quantum optimization algorithm using a set of parameters that define the Gibbs state to solve the combinatorial optimization problem, wherein solving the combinatorial optimization problem comprises determining a ground state of a Hamiltonian of the quantum system.

### BACKGROUND

The subject disclosure relates to quantum optimization, and more specifically, to Gibbs state-based quantum optimization for combinatorial optimization problems.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate Gibbs state-based quantum optimization for combinatorial optimization problems are provided.

According to an embodiment, a system can comprise a memory that stores computer executable components. The system can further comprise a processor that executes at least one of the computer executable components that can prepare a Gibbs state of a quantum system that represents a combinatorial optimization problem, wherein the Gibbs state is a quantum state that minimizes free energy of the quantum system. In various embodiments, the at least one of the computer executable components can further initialize a quantum optimization algorithm using a set of parameters that define the Gibbs state to solve the combinatorial optimization problem, wherein solving the combinatorial optimization problem comprises determining a ground state of a Hamiltonian of the quantum system.

According to another embodiment, a computer-implemented method can comprise preparing, by a system operatively coupled to a processor, a Gibbs state of a quantum system that represents a combinatorial optimization problem, wherein the Gibbs state is a quantum state that minimizes free energy of the quantum system. In one or more embodiments, the computer-implemented method can further comprise initializing, by the system, a quantum optimization algorithm using a set of parameters that define the Gibbs state to solve the combinatorial optimization problem, wherein solving the combinatorial optimization problem comprises determining a ground state of a Hamiltonian of the quantum system.

According to another embodiment, a computer program product for Gibbs state-based quantum optimization for combinatorial optimization problems comprising a computer readable storage medium having program instructions embodied therewith, the program instructions executable by a processor to cause the processor to prepare a Gibbs state of a quantum system that represents a combinatorial optimization problem, wherein the Gibbs state is a quantum state that minimizes free energy of the quantum system. In one or more embodiments, the program instructions can be further executable by the processor to cause the processor to initialize a quantum optimization algorithm using a set of parameters that define the Gibbs state to solve the combinatorial optimization problem, wherein solving the combinatorial optimization problem comprises determining a ground state of a Hamiltonian of the quantum system.

### DESCRIPTION OF THE DRAWINGS

FIG. 1 illustrates a block diagram of example, non-limiting system that can facilitate Gibbs state-based quantum optimization for combinatorial optimization problems in accordance with one or more embodiments described herein.

FIG. 2 illustrates a block diagram of example, non-limiting system including a measurement component that can facilitate Gibbs state-based quantum optimization for combinatorial optimization problems in accordance with one or more embodiments described herein.

FIG. 3 illustrates a block diagram of example, non-limiting system including an execution component that can facilitate Gibbs state-based quantum optimization for combinatorial optimization problems in accordance with one or more embodiments described herein.

FIG. 4 illustrates a block diagram of an example, non-limiting quantum system that can at least partially facilitate Gibbs state-based quantum optimization for combinatorial optimization problems in accordance with one or more embodiments described herein.

FIG. 5 illustrates an example, non-limiting block diagram of generating parameters that define a Gibbs state in accordance with one or more embodiments described herein.

FIG. 6 illustrates an example, non-limiting block diagram of generating a parameterized density matrix in accordance with one or more embodiments described herein.

FIG. 7 illustrates an example, non-limiting diagram of an algorithm facilitating Gibbs state-based quantum optimization for combinatorial optimization problems in accordance with one or more embodiments described herein.

FIG. 8 illustrates a flow diagram of an example, non-limiting method that can facilitate Gibbs state-based quantum optimization for combinatorial optimization problems in accordance with one or more embodiments described herein.

FIG. 9 illustrates a flow diagram of an example, non-limiting method that can facilitate Gibbs state-based quantum optimization for combinatorial optimization problems in accordance with one or more embodiments described herein.

FIG. 10 illustrates a flow diagram of an example, non-limiting method that can facilitate Gibbs state-based quantum optimization for combinatorial optimization problems in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can comprise a memory that stores computer executable components. The system can further comprise a processor that executes at least one of the computer executable components that can prepare a Gibbs state of a quantum system that represents a combinatorial optimization problem, wherein the Gibbs state is a quantum state that minimizes free energy of the quantum system. In various embodiments, the at least one of the computer executable components can further initialize a quantum optimization algorithm using a set of parameters that define the Gibbs state to solve the combinatorial optimization problem, wherein solving the combinatorial optimization problem comprises determining a ground state of a Hamiltonian of the quantum system. Such embodiments of the system can provide a number of advantages, including mitigating barren plateaus in quantum optimization, improving processing efficiency of quantum optimization, and increasing speed of convergence during quantum optimization.

In one or more embodiments of the aforementioned system, preparing the Gibbs state of the quantum system can comprise: preparing an initial quantum state in a computational basis; applying the variational quantum circuit to the initial quantum state; obtaining measurements of the variational quantum circuit; and generating a parameterized density matrix in the computational basis based on the measurements. Such embodiments of the system can provide a number of advantages, including increasing speed of convergence during quantum optimization.

In one or more embodiments of the aforementioned system, generating the parameterized density matrix can comprise: determining probabilities of observing respective bitstrings; and generating the parameterized density matrix based on the probabilities of measuring the respective bitstrings. Such embodiments of the system can provide a number of advantages, including increasing speed of convergence during quantum optimization.

In one or more embodiments of the aforementioned system, the at least one of the computer executable components can further: determine an expectation value of the Hamiltonian using the parameterized density matrix; and determine an entropy term of the Gibbs state using the parameterized density matrix. Such embodiments of the system can provide a number of advantages, including mitigating barren plateaus in quantum optimization and increasing speed of convergence during quantum optimization.

In one or more embodiments of the aforementioned system, the at least one of the computer executable components can further determine the free energy of the quantum system based on the expectation value and the entropy term. Such embodiments of the system can provide a number of advantages, including improving processing efficiency of quantum optimization.

In one or more embodiments of the aforementioned system, the at least one of the computer executable components can further: create a schedule of an inverse temperature parameter; and iteratively prepare the Gibbs state over the schedule of the inverse temperature parameter. Such embodiments of the system can provide a number of advantages, including mitigating barren plateaus in quantum optimization, improving processing efficiency of quantum optimization, and increasing speed of convergence during quantum optimization.

In one or more embodiments of the aforementioned system, the at least one of the computer executable components can further compute the expectation value or the entropy term using a real-amplitude ansatz. Such embodiments of the system can provide a number of advantages, including improving processing efficiency of quantum optimization.

According to various embodiments, the above-described system can be implemented as a computer-implemented method or as a computer program product.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Quantum optimization leverages principles of quantum mechanics to solve complex optimization problems across various fields (e.g., logistics, finance, artificial intelligence). In particular, quantum optimization can be used to solve combinatorial optimization problems, where the objective is to identify a best or optimal combination of variables from a large set of possible configurations. To solve such complex optimization problems, quantum optimization employs quantum circuits, and more specifically variational quantum circuits (VQCs). VQCs are a class of quantum algorithms designed to optimize a problem by minimizing a cost function. VQCs consist of parameterized quantum gates whose parameters are iteratively adjusted to find the minimum of a given objective function.

However, despite leveraging quantum optimization for solving combinatorial optimization problems, existing techniques are susceptible to barren plateaus. Barren plateaus occur when the cost function's gradient becomes extremely flat, making it difficult for an optimizer to find a direction that leads to the global minimum. In the context of VQCs, barren plateaus refer to regions in the parameter space where the gradient of the cost function is nearly zero, hindering the effective adjustment of parameters. Barren plateaus can be especially prevalent in combinatorial optimization, as the complexity of the solution space can exacerbate the difficulty of finding optimal solutions. The solution space for combinatorial optimization problems exponentially grows, defined by 2^{N}, where N represents the number of variables. Consequently, a more scalable and efficient method for solving combinatorial optimization problems that improves convergence speed while reducing the occurrence of barren plateaus can be desirable.

Furthermore, due to the exponential growth of the solution space in combinatorial optimization problems, the success of solving combinatorial optimization problems heavily depends on selecting suitable initial variational parameters. The selection of the initial variational parameters is crucial because they dictate the behavior and performance of the variational quantum circuit. Unfortunately, existing techniques do not provide efficient methods for determining or obtaining a suitable initial set of variational parameters that can improve the processing efficiency of solving combinatorial optimization problems and mitigate occurrences of barren plateaus As a result, efficiently finding the initial set of variational parameters remains a significant challenge, given the exponential number of possible configurations in combinatorial problems, and thereby necessitating a method to determine such suitable initial variational parameters. In other words, a method for obtaining an effective set of initial parameters for the variational quantum circuit can be desirable.

In view of the problems discussed above, in relation to quantum optimization of combinatorial optimization problems, the present disclosure can be implemented to produce a solution to one or more of these problems by preparing a Gibbs state of a quantum system that represents a combinatorial optimization problem. By preparing the Gibbs state, a set of parameters that define the Gibbs state can be used as the initial parameters of the VQC for quantum optimization algorithms to solve the combinatorial optimization problem. By determining suitable initial parameters of the VQC based on the Gibbs state, the quantum optimization algorithm can be performed efficiently, mitigating occurrences of barren plateaus allowing and improved convergence speed. The Gibbs state, which represents a thermal equilibrium distribution at a given temperature, provides a probabilistic distribution over quantum states that favors lower-energy (or lower-cost) configurations. By initializing the initial parameters of the VQC based on the Gibbs state, the quantum optimization algorithm is more likely to start closer to an optimal or near-optimal solution in the solution space. This reduces the need for extensive searching and fine-tuning during the optimization process, thereby leading to faster convergence and a higher likelihood of avoiding barren plateaus. Therefore, using the Gibbs state to determine initial parameters can improve the efficiency and effectiveness of the quantum optimization algorithm.

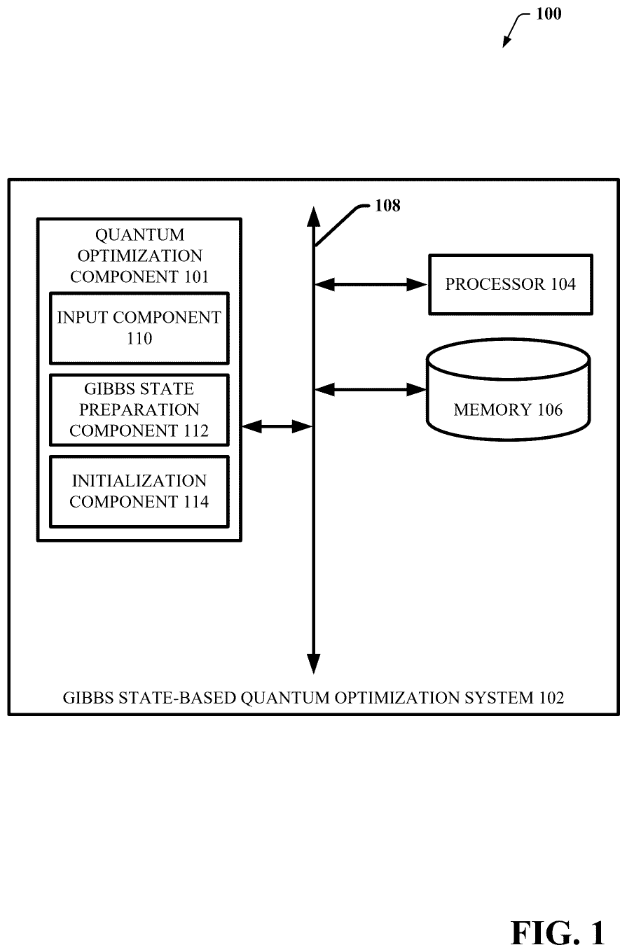

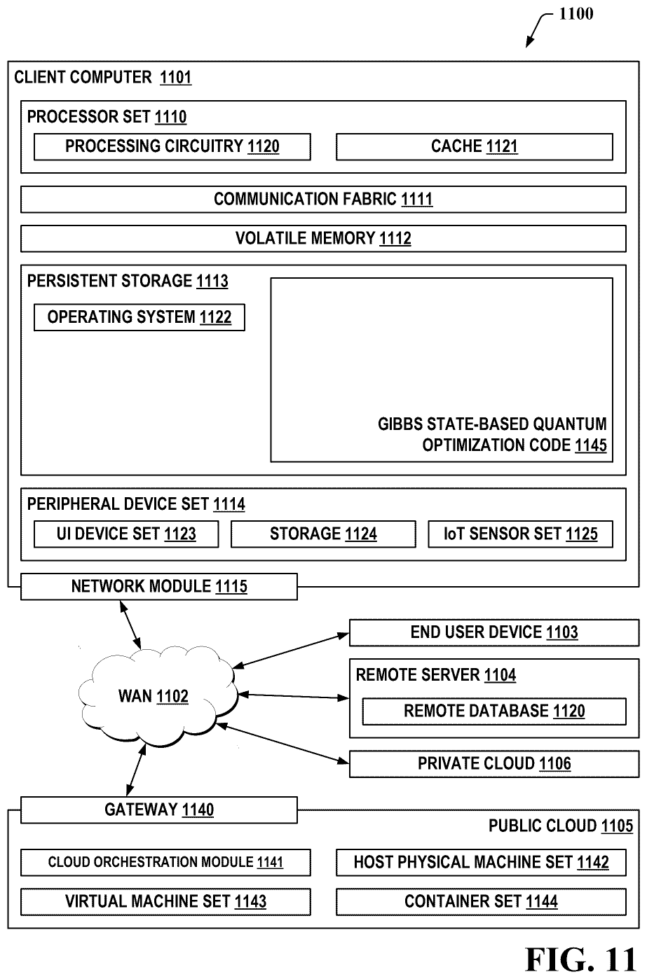

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 (e.g., system 100) as illustrated at FIG. 1, and/or systems thereof, can further comprise, be associated with and/or be coupled to one or more computer and/or computing-based elements described herein with reference to an operating environment, such as the operating environment 1100 illustrated at FIG. 11. For example, system 100 can be associated with, such as accessible via, a computing environment 1100 described below with reference to FIG. 11, such that aspects of processing can be distributed between system 100 and the computing environment 1100. In one or more described embodiments, computer and/or computing-based elements can be used in connection with implementing one or more of the systems, devices, components and/or computer-implemented operations shown and/or described in connection with FIG. 1 and/or with other figures described herein.

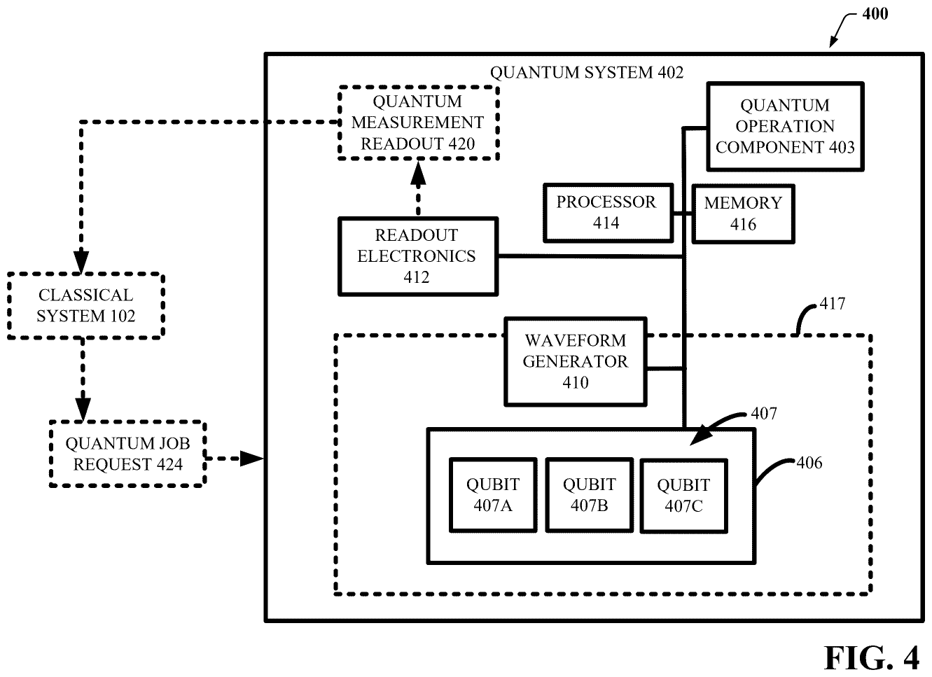

FIG. 1 illustrates block diagram of an example, non-limiting system 100 that can facilitate Gibbs state-based quantum optimization for combinatorial optimization problems in accordance with one or more embodiments described herein. That is, the non-limiting system 100 can facilitate Gibbs state-based quantum optimization for combinatorial optimization problems, in combination with employment of a quantum system 402 (FIG. 4). Aspects of systems (e.g., Gibbs state-based quantum optimization system 102 and the like), apparatuses or processes in various embodiments of the present invention, can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.), can cause the machines to perform the operations described.

Gibbs state-based quantum optimization system 102 can comprise processor 104, memory 106, and quantum optimization component 101, the quantum optimization component 101 comprising input component 110, Gibbs state preparation component 112, and/or initialization component 114.

System 100 and/or the components of system 100 can be employed to use hardware and/or software to solve problems that are highly technical in nature (e.g., related to quantum computing, intelligent profiling predictions of quantum environments, optimized resource allocation, etc.), that are not abstract and that cannot be performed as a set of mental acts by a human. Further, some of the processes performed may be performed by specialized computers for carrying out defined tasks related to optimizing resource allocation in quantum environments. The system 100 and/or components of the system can be employed to solve new problems that arise through advancements in technologies mentioned above, quantum computing, and/or the like. The system 100 can provide technical improvements in terms of optimizing resource allocations between classical and quantum components in quantum environments and improving efficiency of execution by optimizing resource allocations prior to execution, etc.

Discussion turns briefly to processor 104, memory 106 and bus 108 of system 100. For example, in one or more embodiments, the system 100 can comprise processor 104 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 100 can comprise a computer-readable memory (e.g., memory 106) that can be operably connected to the processor 104. Memory 106 can store computer-executable instructions that, upon execution by processor 104, can cause processor 104 and/or one or more other components of system 100 (e.g., quantum optimization component 101, input component 110, Gibbs state preparation component 112, initialization component 114) to perform one or more actions. In one or more embodiments, memory 106 can store computer-executable components (e.g., quantum optimization component 101, input component 110, Gibbs state preparation component 112, initialization component 114).

System 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

As described above, in addition to the processor 104 and/or memory 106 described above, system 100 can comprise one or more computer and/or machine readable, writable and/or executable components and/or instructions that, when executed by processor 104, can enable performance of one or more operations defined by such component(s) and/or instruction(s).

In various embodiments, input component 110 can receive an objective function to be optimized that represents the combinatorial optimization problem. The combinatorial optimization problem can involve a set of decision variables that dictate the objective function. Each of the decision variables can have two states (e.g., 0 and 1) that indicate selection of such decision variable. In various cases, the number of decision variables can be denoted by N, and thus the solution space can be defined as 2^{N}.

In various aspects the objective function can comprise any suitable format, such as a mathematical expression involving the set of decision variables. In various cases, the objective function can be any suitable electronic data (e.g., one or more scalars, one or more vectors, one or more matrices, one or more tensors, one or more character strings, or any suitable combination thereof) that indicates, specifies, or otherwise conveys the objective function. In various embodiments, the input component 110 can encode the objective function into a Hamiltonian, denoted by H. Accordingly, the ground state of the Hamiltonian H can correspond to an optimal solution of the combinatorial optimization problem.

In various embodiments, the input component 110 can receive a set of constraints. In various aspects, the set of constraints can define constraints on the solution to the combinatorial optimization problem. In various embodiments, input component 110 can incorporate the set of constraints into the objective function. In various cases, the objective function can be any suitable electronic data (e.g., one or more scalars, one or more vectors, one or more matrices, one or more tensors, one or more character strings, or any suitable combination thereof). As non-limiting examples, the set of constraints can define penalty terms in the Hamiltonian H or optimization criteria (e.g., threshold conditions).

In various embodiments, the input component 110 can receive any suitable data in connection with the combinatorial optimization problem. For example, the input component 110 can receive problem instance data that comprises a specific instance of the combinatorial optimization problem. In various aspects, the problem instance data can comprise any suitable format. As a non-limiting example, for graph-based combinatorial problems (e.g., traveling salesman problem, Max-Cut problem), the problem instance data can comprise a graph defined by a set of vertices, edges, and weights. As another non-limiting example, the problem instance data can comprise a set of Boolean variables with defined constraints. As yet another non-limiting example, the problem instance data can comprise a list of items with associated weights and values. As still another non-limiting example, the combinatorial optimization problem can be a scheduling problem (e.g., job shop scheduling problem, vehicle routing problem). As yet another non-limiting example, the combinatorial optimization problem can be an assignment problem (e.g., quadratic assignment problem). As even another non-limiting example, the combinatorial optimization problem can be a network flow problem (e.g., maximum flow problem, minimum cost flow problem). As even yet another non-limiting example, the combinatorial optimization problem can be a matching problem (e.g., bipartite matching). In any case, the input component 110 can receive any data in connection with combinatorial optimization problem.

In various embodiments, Gibbs state preparation component 112 can, as described herein, prepares a Gibbs state of a quantum system that represents the combinatorial optimization problem. The Gibbs state is a quantum state that describes the quantum system at thermal equilibrium at a given temperature T. The Gibbs state, denoted by ρ(θₒₚₜ), is a quantum state that minimizes a free energy of the quantum system. That is, the Gibbs state can be defined by a set of parameters θ of the VQC that minimizes the free energy of the quantum system. In various aspects, the set of parameters θ of the VQC that minimizes the free energy of the quantum system can be considered as an optimal set of parameters for initializing the quantum optimization algorithm to solve the combinatorial optimization problem.

The free energy, denoted by F, of the quantum system can be defined by the following equation:

$$F ( ρ ( θ ) ) = T r ( ρ ( θ ) H ) - \frac{1}{β} ρ ( θ ) ln ρ ( θ ) ,$$

where density matrix ρ(θ) defines a quantum state of the quantum system and β denotes an inverse temperature parameter. In various aspects, the free energy F comprises two terms. The free energy F comprises an energy term, defined by Tr(ρ(θ)H), and an entropy term, defined by

$$\frac{1}{β} ρ ( θ ) ln ρ ( θ ) .$$

The density matrix ρ(θ) is a parameterized density matrix by the set of parameters θ of the VQC.

The Gibbs state (e.g., the minimum of the free energy F) can be achieved when

$$ρ ( {θ}_{opt} ) = \frac{1}{Z} {e}^{- β H}$$

where Z=Tr(e^{-βH}). The Boltzmann operator, defined by e^{-βH}, describes exponential suppression of higher energy states, where H is the Hamiltonian of the quantum system, to encapsulate the influence of temperature on energy states of the quantum system. Further, Z denotes a partition function that ensures the density matrix ρ(θ) is normalized, involving a trace (e.g., sum of diagonal elements of a matrix) of the Boltzmann operator.

In various aspects, the Hamiltonian H arising from combinatorial optimization problems is diagonal. That is, the Hamiltonian is in its eigen basis (e.g., the matrix representation of the Hamiltonian has non-zero elements along its main diagonal with non-diagonal elements equal to zero). This indicates that each quantum state is an eigenstate of the Hamiltonian, and the corresponding diagonal elements represent the energy eigenvalues associated with such quantum states. Accordingly, when the Hamiltonian is diagonal, the Gibbs state can be reformulated as a superposition of quantum states, defined by

$$ρ = \frac{1}{{Z}^{′}} {\sum }_{i} {e}^{- β {E}_{i}} \vert i 〉 〈 i \vert$$

where Z′=Σᵢe^{-βE}^{ᵢ}. In this manner, the Gibbs state is a linear combination of all possible quantum states |i [symbol] with a Boltzmann weight e^{-βE}^{ᵢ} (e.g., weight applied to the energy state |i [symbol] based on β), where Eᵢ denotes the energy of the i-th quantum state. Therefore, at higher values of inverse temperature parameter β, the quantum states with lower energy have higher Boltzmann weights, meaning they are more likely to be occupied in the quantum system.

In various embodiments, the Gibbs state preparation component 112 can, as described herein, generate the parameterized density matrix ρ(θ) to prepare the Gibbs state of the quantum system. In various aspects, the Gibbs state preparation component 112 can determine the free energy of the quantum state of the quantum system based on the parameterized density matrix. Specifically, the Gibbs state preparation component 112 can compute the energy term and the entropy term based on the parameterized density matrix, wherein the energy term is an expectation value of the Hamiltonian with respect to the quantum state described by the density matrix. In various embodiments, the Gibbs state preparation component 112 can iteratively optimize the free energy to obtain the set of parameters θ of the VQC that minimizes the free energy of the quantum system, wherein the set of parameters θ defines the Gibbs state.

In various embodiments, the initialization component 114 can, as described herein, initialize a quantum optimization algorithm using the set of parameters θ that defines the Gibbs state. Therefore, the quantum optimization algorithm effectively starts with a quantum state that is already inclined toward lower energies. This can be considered a “warm start” that places the quantum optimization algorithm closer to the ground state before optimization, reducing the number of iterations or adjustments needed to find the true ground state. In other words, initialization component 114 can initialize the quantum optimization algorithm can be initialized with pre-optimized parameters that are already close to an expected optimal solution.

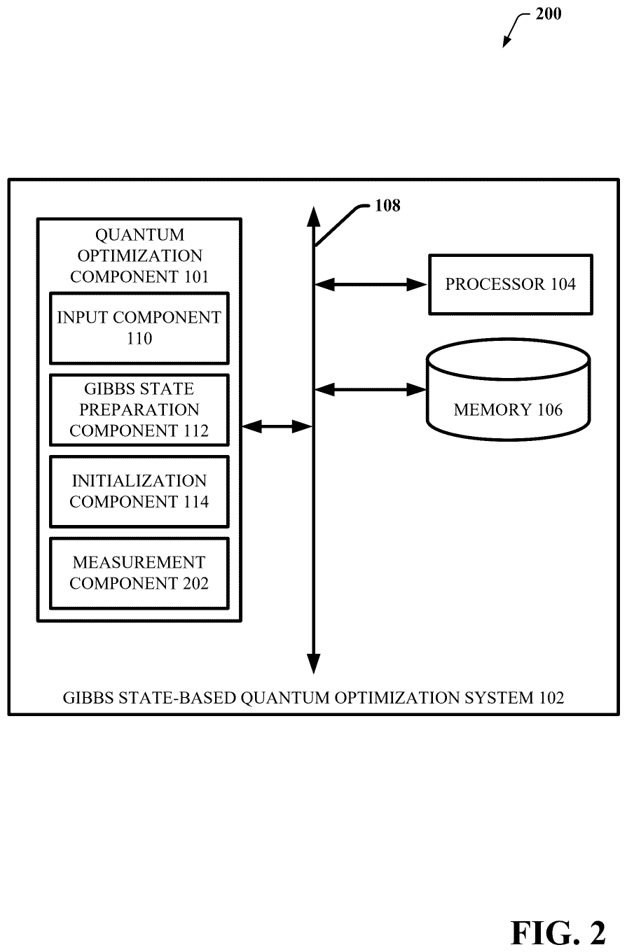

FIG. 2 illustrates a block diagram of example, non-limiting system 200 including a measurement component that can facilitate Gibbs state-based quantum optimization for combinatorial optimization problems in accordance with one or more embodiments described herein. As shown, the system 200 can, in some cases, comprise the same components as the system 100, and can further comprise a measurement 202.

In various embodiments, the measurement component 202 can prepare an initial quantum state of the quantum system in a computational basis. The computational basis is a set of orthogonal quantum states that correspond to classical binary states (e.g., set of basis states). For example, the computational basis can be {|0 [symbol] , |1 [symbol] } for a single qubit. As another example, the computational basis can be {|00 [symbol] , |01 [symbol] , |10 [symbol] , |11 [symbol] } for two qubits.

In various aspects, the measurement component 202 can prepare the initial quantum state using the parameterized density matrix in the computational basis state. In various cases, the measurement component 202 can prepare the initial quantum state in the computational basis by setting the quantum system to a particular mixture of the basis states that is defined by pᵢ(θ). Accordingly, the measurement 202 can prepare the parameterized density matrix in the computational basis, defined by ρ(θ)=Σpᵢ(θ)| [symbol] .

In various instances, the measurement component 202 can apply the VQC to the initial quantum state to obtain measurements of the VQC. In other words, the measurement component 202 can measure the VQC to obtain the measurements. In various aspects, the Gibbs state preparation component 112 can generate the parameterized density matrix ρ(θ) in the computational basis based on the measurements, and therefore the free energy F defined by

$$F ( ρ ( θ ) ) = T r ( ρ ( θ ) H ) - \frac{1}{β} ρ ( θ ) ln ρ ( θ )$$

can be further simplified to

$$F ( ρ ( θ ) ) = {\sum }_{i} {p}_{i} ( θ ) {E}_{i} + \frac{1}{β} {\sum }_{i} {p}_{i} ( θ ) ln {p}_{i} ( θ ) ,$$

allowing for classical computation of the energy term and the entropy term to determine the free energy.

In various embodiments, the Gibbs state preparation component 112 can compute the entropy term and the energy term using a real-amplitude ansatz. A real-amplitude ansatz is a type of quantum circuit where the quantum state prepared by the ansatz has real-number coefficients (amplitudes) in front of the computational basis states. This real-amplitude ansatz can simplify the quantum circuit to make the optimization process more efficient. In various aspects, the real-amplitude ansatz can be defined by U(θ)|0 [symbol] =\sqrt{Σpᵢ(θ)|i [symbol]}. When the unitary operation U(θ) is applied to an initial zero state |0 [symbol] , the resulting quantum state is a superposition of computational basis states with real-number coefficients (amplitudes) \sqrt{pᵢ(θ)}. This can restrict the quantum state to a specific form, which can be advantageous for computing the energy term and the entropy term efficiently based on the parameterized density matrix. Thus, the Gibbs state preparation component 112 can efficiently determine the free energy of the quantum system based on the energy term and the entropy term, and thereby prepare the Gibb state.

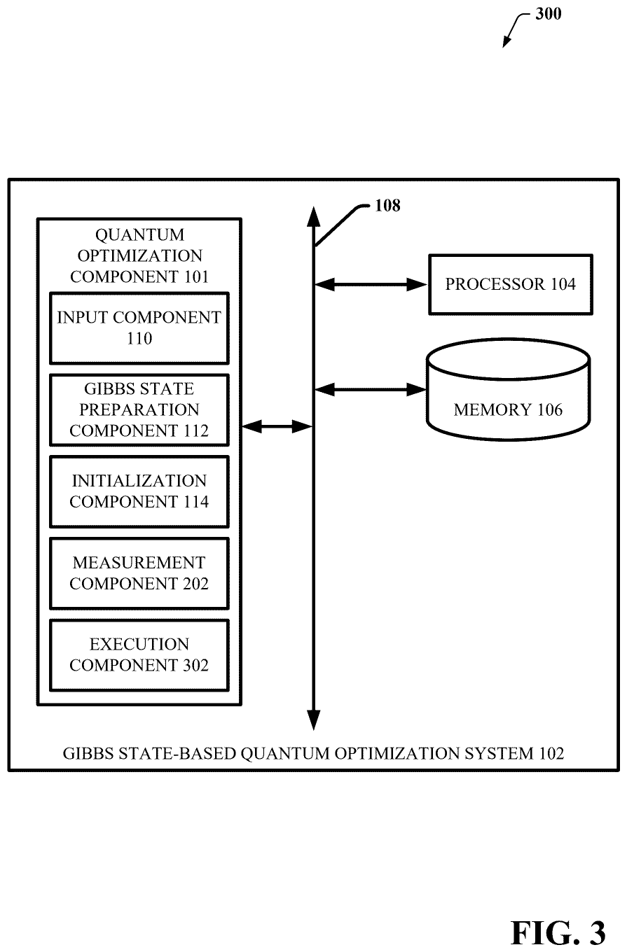

FIG. 3 illustrates a block diagram of example, non-limiting system 300 including an execution component that can facilitate Gibbs state-based quantum optimization for combinatorial optimization problems in accordance with one or more embodiments described herein. As shown, the system 300 can, in some cases, comprise the same components as the system 200, and can further comprise an execution component 302.

In various embodiments, the initialization component 114 can engage the execution component 302 to execute the quantum optimization algorithm using the set of parameters that define the Gibbs state. In various aspects, the execution component 302 can execute the quantum optimization algorithm to determine the ground state of the Hamiltonian of the quantum system, which corresponds to the lowest energy state of the quantum system. That is, the execution component 302 can optimize the set of parameters that define the Gibbs state to minimize the objective function that represents the combinatorial optimization problem.

In various instances, the quantum optimization algorithm can be a variational quantum eigensolver (VQE). In various embodiments, the execution component 302 can construct and measure a quantum state using a parameterized quantum circuit based on the set of parameters that define the Gibbs state. Accordingly, the execution component 302 can iteratively adjust the set of parameters to minimize the free energy until the ground state of the Hamiltonian is determined. By determining and using the set of parameters that define the Gibbs state to initialize the quantum optimization algorithm, convergence speed can be increased by providing a starting point where quantum states with lower energy are more likely to be occupied, thereby guiding the quantum optimization algorithm closer to the ground state before optimization. In other words, the set of parameters that define the Gibbs state bias the quantum system toward lower energy states, which facilitates faster convergence in finding the ground state.

Turning to FIG. 4, one or more embodiments described herein can include one or more devices, systems and/or apparatuses that can provide a process to facilitate Gibbs state-based quantum optimization for combinatorial optimization problems. Accordingly, at FIG. 4, illustrated is a block diagram of an example, non-limiting system 400 that can at least partially facilitate such a process. While referring here to one or more processes, facilitations and/or uses of the non-limiting system 400, description provided herein, both above and below, also can be relevant to one or more other non-limiting systems described herein, such as the non-limiting systems 100, 200, and/or 300.

As illustrated at FIG. 4, the non-limiting system 400 can comprise a quantum system 402 that can be employed with or separate from the classical system 102.

Generally, the quantum system 402 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 420, can be responsive to the quantum job request 424 and associated input data and can be based at least in part on the input data, quantum functions and/or quantum computations.

In one or more embodiments, the quantum system 402 can comprise components, such as a quantum operation component 403, a quantum processor 406, pulse component 410 (e.g., a waveform generator) and/or a readout electronics 412 (e.g., readout component). In one or more other embodiments, the readout electronics 412 can be comprised at least partially by the classical system 102 and/or be external to the quantum system 402. The quantum processor 406 can comprise one or more, such as plural, qubits 407. Individual qubits 407A, 407B and 407C, for example, can be fixed frequency and/or single junction qubits, such as transmon qubits.

In one or more embodiments, a memory 416 and/or processor 414 can be associated with the quantum operation component 403, where suitable. The processor 414 can be any suitable processor. The processor 414 can generate one or more instructions for controlling the one or more processes of the quantum operation component 403.

The quantum operation component 403 can obtain (e.g., download, receive, search for and/or the like) a quantum job request 424 requesting execution of one or more quantum programs and/or a physical qubit layout. The quantum job request 424 can be provided in any suitable format, such as a text format, binary format and/or another suitable format. In one or more embodiments, the quantum job request 424 can be obtained by a component other than of the quantum system 402, such as a by a component of the classical system 102.

The quantum operation component 403 can determine mapping of one or more quantum logic circuits for executing a quantum program. In one or more embodiments, the quantum operation component 403 and/or quantum processor 406 can direct the waveform generator 410 to generate one or more pulses, tones, waveforms and/or the like to affect one or more qubits 407, such as in response to a quantum job request 424.

The waveform generator 410 can generally cause the quantum processor 406 to perform one or more quantum processes, calculations and/or measurements by creating a suitable electro-magnetic signal. For example, the waveform generator 410 can operate one or more qubit effectors, such as qubit oscillators, harmonic oscillators, pulse generators and/or the like to cause one or more pulses to stimulate and/or manipulate the state(s) of the one or more qubits 407 comprised by the quantum system 402.

The quantum processor 406 and a portion or all of the waveform generator 410 can be contained in a cryogenic environment, such as generated by a cryogenic environment 417, such as effected by a dilution refrigerator. Indeed, a signal can be generated by the waveform generator 410 to affect one or more of the plurality of qubits 407. Where the plurality of qubits 407 are superconducting qubits, cryogenic temperatures, such as about 4K or lower, can be employed for function of these physical qubits. Accordingly, one or more elements of the readout electronics 412 also can be constructed to perform at such cryogenic temperatures.

The readout electronics 412, or at least a portion thereof, can be contained in the cryogenic environment 417, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

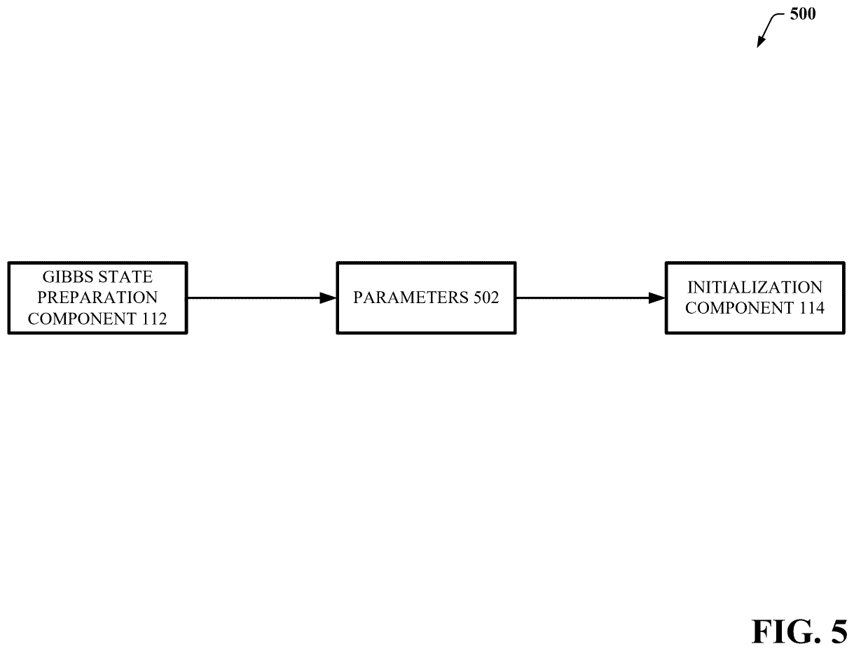

FIG. 5 illustrates an example, non-limiting block diagram 500 of generating parameters that define a Gibbs state in accordance with one or more embodiments described herein.

In various embodiments, the Gibbs state preparation component 112 can prepare the Gibbs state of the quantum system that minimizes the free energy. That is, the Gibbs state preparation component 112 can determine parameters 502 that define the Gibbs state of the quantum system. In various aspects, the parameters 502 can be any suitable electronic data (e.g., one or more scalars, one or more vectors, one or more matrices, one or more tensors, one or more character strings, or any suitable combination thereof).

In some instances, the Gibbs state preparation component 112 can classically optimize the free energy to determine the parameters 502 that minimizes the free energy. More specifically, the Gibbs state preparation component 112 can iteratively determine the parameters 502 until a minimum of the free energy is achieved.

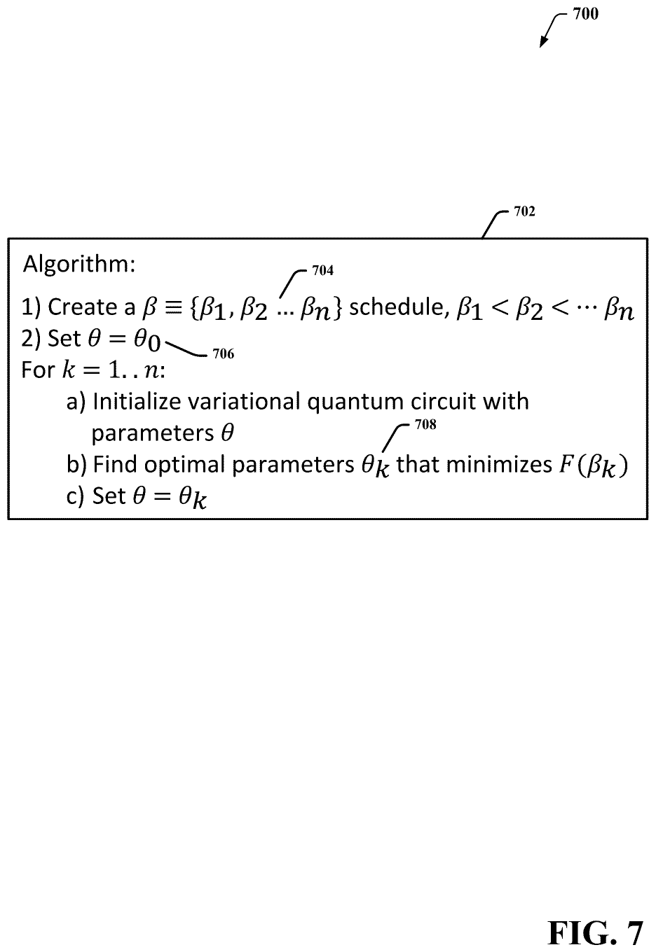

In some cases, the Gibbs state preparation component 112 can iteratively optimize the free energy of the quantum system over a schedule of the inverse temperature parameter β to determine the parameters 502 that minimize the free energy at a highest value of the inverse temperature parameter β. Non-limiting aspects are described with respect to FIG. 7.

In any case, the initialization component 114 can receive the parameters 502 to initialize the quantum optimization algorithm with the parameters 502. Therefore, the parameters 502 can provide pre-optimized parameters to the quantum optimization algorithm that are closer to the ground state solution of the combinatorial optimization problem, thereby mitigating barren plateau occurrences and increasing convergence speed of the quantum optimization algorithm.

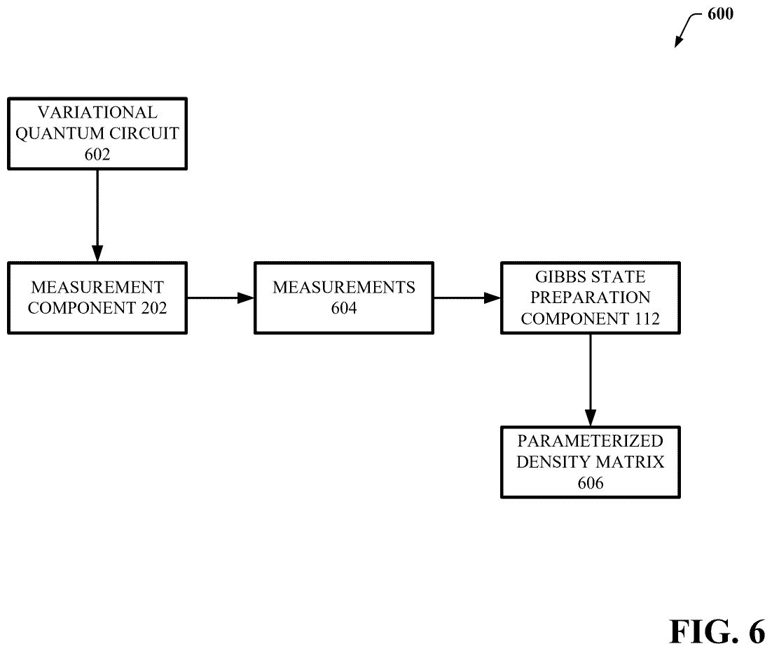

FIG. 6 illustrates an example, non-limiting block diagram 600 of generating a parameterized density matrix in accordance with one or more embodiments described herein.

As shown, in various aspects, the measurement component 202 can receive a VQC 602. In various embodiments, the measurement component 202 can apply the VQC 602 to the initial quantum state of the quantum system, evolving the initial quantum state towards a solution of the combinatorial optimization problem (e.g., the ground state of the Hamiltonian).

In various instances, the measurement component 202 can measure the VQC 602 to obtain measurements 604. In some cases, the measurement component 202 can measure the VQC 602 a plurality of times to obtain measurements 604. In any case, the measurements 604 can be any suitable electronic data (e.g., one or more scalars, one or more vectors, one or more matrices, one or more tensors, one or more character strings, or any suitable combination thereof).

In various aspects, the Gibbs state preparation component 112 can receive the measurements 604 to determine probabilities of observing respective bitstrings. Particularly, the Gibbs state preparation component 112 can determine the probability pᵢ(θ) of a bitstring i. Measuring the VQC a plurality of times yields measurements 604 that comprise probabilities of the bitstrings by sampling the quantum state a plurality of times. The frequency of each bitstring appearing in the measurements 604 can reflect the respective probability in the quantum state's distribution. In any instance, Gibbs state preparation component 112 can generate a parameterized density matrix 606 based on the measurements 604, and more specifically based on the probabilities of the respective bitstrings.

FIG. 7 illustrates an example, non-limiting diagram 700 of an algorithm facilitating Gibbs state-based quantum optimization for combinatorial optimization problems in accordance with one or more embodiments described herein.

In various aspects, the Gibbs state preparation component 112 can utilize algorithm 702 to prepare the Gibbs state of the quantum system. Specifically, the Gibbs state preparation component 112 can utilize algorithm 702 to iteratively optimize the free energy to obtain the set of parameters of the VQC that minimizes the free energy at a highest value of the inverse temperature parameter. In various embodiments, the Gibbs state preparation component 112 can create a schedule 704 of the inverse temperature parameter β, denoted by β={β₀, β₁, . . . }. The schedule 704 can comprise n values for any positive integer n. That is, the schedule 704 can comprise a β₀ to a βₙ. Furthermore, in various cases, the schedule 704 can be in increasing order, such that β₀<β₁< . . . <βₙ. In various embodiments, the Gibbs state preparation component 112 can initialize the set of parameters θ to initial parameters 706, denoted by θ₀.

In various aspects, the Gibbs state preparation component 112 can iteratively prepare the Gibbs state over schedule 704 of the inverse temperature parameter. More specifically the Gibbs state preparation component 112 can initialize a VCQ with the set of parameters θ and determine parameters 708, denoted by θₖ where k is any integer such that 0<k≤n, that minimizes the free energy of the quantum system for each βₖ in the schedule 704 (e.g., that minimizes F(βₖ)). If convergence is reached for determining the parameters 708, the Gibbs state preparation component 112 can set the set of parameters θ of the VQC to the parameters 708. Therefore, after iteratively determining the set of parameters that defines the Gibbs state, the set of parameters θ can define the Gibbs state at a highest value of the inverse temperature parameter, causing the quantum states with lower energy to have higher Boltzmann weights and be more likely to be occupied in the quantum system. Accordingly, the initialization component 114 can initialize the quantum optimization algorithm with the set of parameters that define the Gibbs state at the highest value of the inverse temperature parameter. Such embodiments can cause the quantum optimization algorithm to be initialized with pre-optimized parameters that are closer to the ground state of the Hamiltonian before optimization.

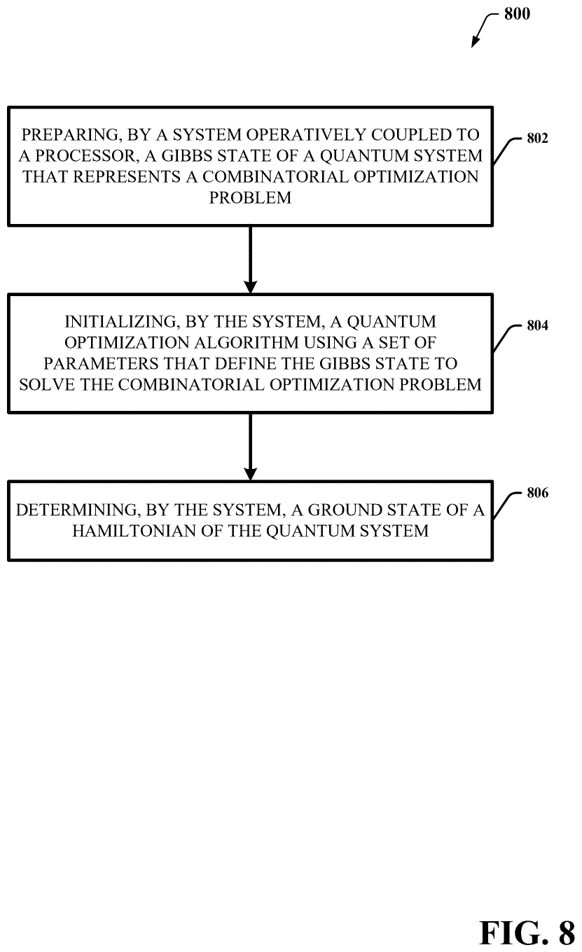

FIG. 8 illustrates a flow diagram of an example, non-limiting, computer implemented method 800 that facilitates Gibbs state-based quantum optimization for combinatorial optimization problems in accordance with one or more embodiments described herein. Repetitive description of like elements employed in other embodiments described herein is omitted for sake of brevity.

At 802, non-limiting method 800 can include preparing, by a system (e.g., Gibbs state-based quantum optimization system 102 and/or Gibbs state preparation component 112) operatively coupled to a processor (e.g., 104), a Gibbs state of a quantum system that represents a combinatorial optimization problem.

At 804, non-limiting method 800 can include initializing, by the system (e.g., initialization component 114), a quantum optimization algorithm using a set of parameters that define the Gibbs state to solve the combinatorial optimization problem.

At 806, non-limiting method 800 can include determining, by the system (e.g., execution component 302), a ground state of a Hamiltonian of the quantum system.

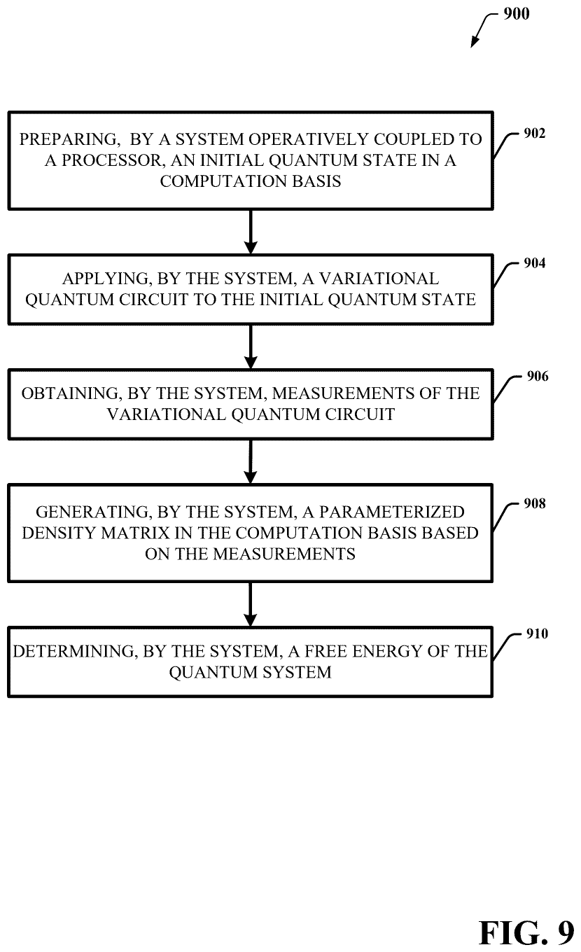

FIG. 9 illustrates a flow diagram of an example, non-limiting, computer implemented method 900 that facilitates Gibbs state-based quantum optimization for combinatorial optimization problems in accordance with one or more embodiments described herein. Repetitive description of like elements employed in other embodiments described herein is omitted for sake of brevity.

At 902, non-limiting method 900 can include preparing, by the system (e.g., measurement component 202), an initial quantum state in a computational basis.

At 904, non-limiting method 900 can comprise applying, by the system (e.g., measurement component 202), a variational quantum circuit to the initial quantum state.

At 906, non-limiting method 900 can comprise obtaining, by the system (e.g., measurement component 202), measurements of the variational quantum circuit.

At 908, non-limiting method 900 can include generating, by the system (e.g., Gibbs state preparation component 112), a parameterized density matrix in the computational basis based on the measurements.

At 910, non-limiting method 900 can include determining, by the system (e.g., evaluation component 19), a free energy of the quantum system.

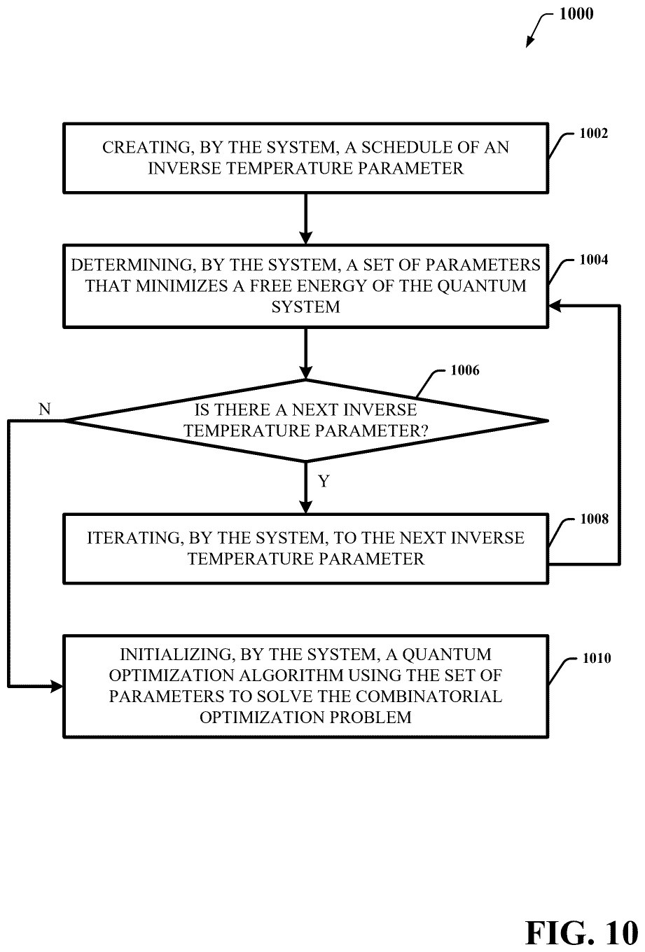

FIG. 10 illustrates a flow diagram of an example, non-limiting, computer implemented method 1000 that facilitates Gibbs state-based quantum optimization for combinatorial optimization problems in accordance with one or more embodiments described herein. Repetitive description of like elements employed in other embodiments described herein is omitted for sake of brevity.

At 1002, non-limiting method 1000 can include creating, by the system (e.g., Gibbs state preparation component 112), a schedule of an inverse temperature parameter (e.g., 704).

At 1004, non-limiting method 1000 can include determining, by the system (e.g., Gibbs state preparation component 112), a set of parameters that minimizes a free energy of the quantum system.

At 1006, non-limiting method 1000 can include determining, by the system (e.g., Gibbs state preparation component 112), if there is a next inverse temperature parameter in the schedule. If yes (e.g., there is a next inverse temperature parameter), the non-limiting method 1000 can proceed to 1008. If no (e.g., there is not a next inverse temperature parameter), the non-limiting method 1000 can proceed to 1010.

At 1008, non-limiting method 1000 can iterating, by the system (e.g., Gibbs state preparation component 112), to the next inverse temperature parameter.

At 1010, non-limiting method 1000 can include initializing, by the system (e.g., initialization component 114), a quantum optimization algorithm using the set of parameters to solve the combinatorial optimization problem.

Gibbs state-based quantum optimization system 102 can provide technical improvements to a processing unit associated with Gibbs state-based quantum optimization system 102. For example, by utilizing a real-amplitude ansatz, computation of the energy term and the entropy term in the free energy of the quantum system can exhibit increased processing efficiency, thereby reducing the workload of a processing unit (e.g., processor 104). In this example, by reducing the workload of such a processing unit (e.g., processor 104), Gibbs state-based quantum optimization system 102 can thereby facilitate improved performance, improved efficiency, and/or reduced computational cost associated with such a processing unit. Further, by utilizing the Gibbs state to initialize the quantum optimization algorithm, the amount of quantum resources utilized by Gibbs state-based quantum optimization system 102 is reduced by increasing convergence speed and mitigating barren plateaus, thereby reducing or removing the additional workload of a QPU of a quantum system associated with the quantum optimization. Gibbs state-based quantum optimization system 102 can thereby facilitate improved performance, improved efficiency, and/or reduced computational cost associated with quantum computation on a quantum processor.

A practical application of Gibbs state-based quantum optimization system 102 is that it allows for execution of quantum optimization algorithms for combinatorial optimization problems with increased efficiency by utilizing a reduced amount of quantum and classical computing resources, in comparison to other methods. For example, quantum optimization of combinatorial optimization problems is prone to barren plateaus, which limits the capability of performing quantum optimization for combinatorial optimization problems. By initializing quantum optimization algorithms with a Gibbs state, Gibbs state-based quantum optimization system 102 can enable Gibbs state-based quantum optimization for combinatorial optimization problems with improved scalability, decreased computation requirements, and improved processing efficiency. Therefore, Gibbs state-based quantum optimization system 102 can enable Gibbs state-based quantum optimization for combinatorial optimization problems that can be operated with reduced quantum and classical hardware requirements, thus promoting efficient quantum optimization.

It is to be appreciated that Gibbs state-based quantum optimization system 102 can utilize various combination of electrical components, mechanical components, and circuitry that cannot be replicated in the mind of a human or performed by a human as the various operations that can be executed by Gibbs state-based quantum optimization system 102 and/or components thereof as described herein are operations that are greater than the capability of a human mind. For instance, the amount of data processed, the speed of processing such data, or the types of data processed by Gibbs state-based quantum optimization system 102 over a certain period of time can be greater, faster, or different than the amount, speed, or data type that can be processed by a human mind over the same period of time. According to several embodiments, Gibbs state-based quantum optimization system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that Gibbs state-based quantum optimization system 102 can include information that is impossible to obtain manually by an entity, such as a human user. For example, the type, amount, and/or variety of information included in Gibbs state-based quantum optimization system 102 can be more complex than information obtained manually by an entity, such as a human user.

FIG. 11 illustrates a block diagram of an example, non-limiting operating environment 1100 in which one or more embodiments described herein can be facilitated. FIG. 11 and the following discussion are intended to provide a general description of a suitable operating environment 1100 in which one or more embodiments described herein at FIGS. 1-10 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as Gibbs state-based quantum optimization code 1145. In addition to block 1145, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1145, as identified above), peripheral device set 1114 (including user interface (UI), device set 1125, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1145 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1125 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes at least one of the computer executable components that:
prepares a Gibbs state of a quantum system that represents a combinatorial optimization problem, wherein the Gibbs state is a quantum state that minimizes free energy of the quantum system; and
initializes a quantum optimization algorithm using a set of parameters that define the Gibbs state to solve the combinatorial optimization problem, wherein solving the combinatorial optimization problem comprises determining a ground state of a Hamiltonian of the quantum system.

2. The system of claim 1, wherein preparing the Gibbs state of the quantum system comprises:
preparing an initial quantum state in a computational basis;
applying the variational quantum circuit to the initial quantum state;
obtaining measurements of the variational quantum circuit; and
generating a parameterized density matrix in the computational basis based on the measurements.

3. The system of claim 2, wherein generating the parameterized density matrix comprises:
determining probabilities of observing respective bitstrings; and
generating the parameterized density matrix based on the probabilities of measuring the respective bitstrings.

4. The system of claim 2, wherein at least one of the computer executable components further:
determines an expectation value of the Hamiltonian using the parameterized density matrix; and
determines an entropy term of the Gibbs state using the parameterized density matrix.

5. The system of claim 4, wherein at least one of the computer executable components further:
determines the free energy of the quantum system based on the expectation value and the entropy term.

6. The system of claim 1, wherein at least one of the computer executable components further:
creates a schedule of an inverse temperature parameter; and
iteratively prepares the Gibbs state over the schedule of the inverse temperature parameter.

7. The system of claim 1, wherein at least one of the computer executable components further:
computes the expectation value or the entropy term using a real-amplitude ansatz.

8. A computer-implemented method, comprising:
preparing, by a system operatively coupled to a processor, a Gibbs state of a quantum system that represents a combinatorial optimization problem, wherein the Gibbs state is a quantum state that minimizes free energy of the quantum system; and
initializing, by the system, a quantum optimization algorithm using a set of parameters that define the Gibbs state to solve the combinatorial optimization problem, wherein solving the combinatorial optimization problem comprises determining a ground state of a Hamiltonian of the quantum system.

9. The computer-implemented method of claim 8, wherein preparing the Gibbs state of the quantum system comprises:
preparing an initial quantum state in a computational basis;
applying the variational quantum circuit to the initial quantum state;
obtaining measurements of the variational quantum circuit; and
generating a parameterized density matrix in the computational basis based on the measurements.

10. The computer-implemented method of claim 9, wherein generating the parameterized density matrix comprises:
determining probabilities of observing respective bitstrings; and
generating the parameterized density matrix based on the probabilities of measuring the respective bitstrings.

11. The computer-implemented method of claim 9, further comprising:
determining, by the system, an expectation value of the Hamiltonian using the parameterized density matrix; and
determining, by the system, an entropy term of the Gibbs state using the parameterized density matrix.

12. The computer-implemented method of claim 11, further comprising:
determining, by the system, the free energy of the quantum system based on the expectation value and the entropy term.

13. The computer-implemented method of claim 8, further comprising:
creating, by the system, a schedule of an inverse temperature parameter; and
iteratively preparing, by the system, the Gibbs state over the schedule of the inverse temperature parameter.

14. The computer-implemented method of claim 11, further comprising:
computing, by the system, the expectation value or the entropy term using a real-amplitude ansatz.

15. A computer program product for Gibbs state-based quantum optimization for combinatorial optimization problems, the computer program product comprising a computer readable storage medium having program instructions embodied therewith, the program instructions executable by a processor to cause the processor to:
prepare a Gibbs state of a quantum system that represents a combinatorial optimization problem, wherein the Gibbs state is a quantum state that minimizes free energy of the quantum system; and
initialize a quantum optimization algorithm using a set of parameters that define the Gibbs state to solve the combinatorial optimization problem, wherein solving the combinatorial optimization problem comprises determining a ground state of a Hamiltonian of the quantum system.

16. The computer program product of claim 15, wherein preparing the Gibbs state of the quantum system comprises:
preparing an initial quantum state in a computational basis;
applying the variational quantum circuit to the initial quantum state;
obtaining measurements of the variational quantum circuit; and
generating a parameterized density matrix in the computational basis based on the measurements.

17. The computer program product of claim 16, wherein generating the parameterized density matrix comprises:
determining probabilities of observing respective bitstrings; and
generating the parameterized density matrix based on the probabilities of measuring the respective bitstrings.

18. The computer program product of claim 16, wherein the program instructions are further executable by the processor to cause the processor to:
determine an expectation value of the Hamiltonian using the parameterized density matrix; and
determine an entropy term of the Gibbs state using the parameterized density matrix.

19. The computer program product of claim 18, wherein the program instructions are further executable by the processor to cause the processor to:
determines the free energy of the quantum system based on the expectation value and the entropy term.

20. The computer program product of claim 15, wherein the program instructions are further executable by the processor to cause the processor to:
create a schedule of an inverse temperature parameter; and
iteratively prepare the Gibbs state over the schedule of the inverse temperature parameter.
